(19) United States
(12) Patent Application Publication
(10) Pub. No.: US 2025/0077683 A1
(43) Pub. Date: Mar. 6, 2025

(54) SYSTEM AND METHOD FOR VULNERABILITY LOCALIZATION BASED ON DEEP LEARNING

(71) Applicant: Huazhong University of Science and Technology, Wuhan (CN)

(72) Inventors: Bin YUAN, Wuhan (CN); Zijing XU, Wuhan (CN); Tiancheng HU, Wuhan (CN); Yueming WU, Wuhan (CN); Deqing ZOU, Wuhan (CN); Hai JIN, Wuhan (CN)

(21) Appl. No.: 18/650,308

(22) Filed: Apr. 30, 2024

(30) Foreign Application Priority Data
Sep. 1, 2023 (CN) 202311132938.4

(51) Int. Cl. G06F 21/57; G06F 21/56

(52) U.S. Cl. CPC G06F 21/577; G06F 21/563

(57) ABSTRACT

The present disclosure relates to a system and method for vulnerability localization based on deep learning, which comprises, at a minimum, a processor configured to: analyze a code file under detection to obtain a first abstract syntax tree devoid of semantic information; build upon the first abstract syntax tree by incorporating data-flow edges and/or control-flow edges, thereby forming a second abstract syntax tree with semantic-flow enhancement; split the second abstract syntax tree to obtain a plurality of second abstract syntax sub-trees; and input these second abstract syntax sub-trees into a pre-established vulnerability detection and localization model. Compared with existing code vulnerability detection methods, the present disclosure employs a semantically-enhanced abstract syntax tree and finely-grained segmentation thereof, enabling both the efficient detection and accurate localization of code vulnerabilities, characterized by swift detection rates, low false positive rates, and commendable interpretability of the detection results.

This application claims priority to Chinese Patent Application No. CN 202311132938.4 filed on Sep. 1, 2023, which is hereby incorporated by reference as if fully set forth herein.

### BACKGROUND OF THE APPLICATION

### Field

The present disclosure generally relates to information security, and more particularly to a system and method for vulnerability localization based on deep learning.

### Description of Related Art

Software vulnerabilities are usually introduced into a system by defective security control design or mistakes made by developers during implementation of software specifications. These defects and mistakes are unavoidable during the software development life cycle from its design to implementation. Thus, static application security testing tools have become popular among software developers to help them identify errors and vulnerabilities in source codes. Existing static application security testing tools often use static software analysis (e.g., taint analysis, data flow analysis) or vulnerability pattern libraries and match rules to find out potential mistakes or vulnerabilities in source codes, and inform developers with reports for subsequent manual check. Static application security testing can produce precise reports and give alarms accordingly. Therein, particular source code lines have been recognized as tending to be impacted by particular types of vulnerability attacks, and then often recited as a weakness. There are many static application security testing tools for developers to choose, including open-source and commercial products. Static application security testing tools are usually used during code review as a part of continuous integration and development, or are activated by developers manually.

Despite their impressive power, static application security testing tools have shortcomings. Firstly, there are often false positives in which codes are mistakenly reported as being subject to attacks. This is usually caused by limits or incompleteness of the rule-pattern matching algorithms, and vulnerabilities existing in inaccessible codes. Secondly, static application security testing tools are less capable of detecting complex context vulnerabilities, making them ineffective in identifying codes subject to attacks, and leading to their high false-negative rate. This is also a limitation of the rule-pattern matching algorithms. For instance, some program behavior, such as integer overflow and underflow, are legal in some scenarios (e.g., cryptography), yet are vulnerable (e.g., memory allocation) in other scenarios. Similarly, use-after-free vulnerabilities are very sensitive to context, and in some cases, they can only be seen when allocation for a long sequence is made during the life cycle of the program.

To overcome these limits, researchers have introduced deep learning into vulnerability detection in recent years. Specifically, application of convolutional, recursive, and graph neural networks to detection of source code vulnerabilities have been reported in previous studies. In a graph neural network, the data flow graph, the control flow graph and the abstract syntax tree represented as a source code are encoded to graph representation of the source code that carries semantic information, and the network then learns the relationship information between each node and its adjacent nodes and edges' states.

While the existing methods of applying a graph neural network to static code analysis exhibit good performance, it is unlikely that software developers adopt or use these models as they do currently with static application security testing tools. Although an abstract syntax tree reflects the rich structural information of a program in terms of syntax, it contains merely syntactic information, without any semantic information, such as the control flow and the data flow, whereas use of a control flow graph in detection also fails to provide data flow information. Furthermore, most control flow graphs merely cover control flows among code blocks, leaving low-level syntactic structures in code blocks ignored. Meanwhile, in some programming languages, a control flow graph is more difficult to obtain than an abstract syntax tree.

The foregoing methods often make predications for the entire functions or code regions, but fail to provide specific location pinpointing for the types of vulnerabilities detected. This means that a developer using such a tool has to search for vulnerabilities in hundreds of lines of codes. If the used tool does not conduct classification of vulnerabilities, the search will be even more difficult as the developer does not know what to look for or what to do to remedy the weakness. With the high frequency of false positives seen in the existing machine learning technology, this issue is further exacerbated.

It is thus desirable to have the abstract syntax tree containing semantic information and to have a fine-grained, rapid method for subtrees split so as to effectively detect and locate vulnerabilities.

For example, China Patent Publication No. CN115017514A discloses an intelligent contract vulnerability detection method and application based on the abstract syntax tree. The method comprises: performing lexical analysis and syntactic analysis on the source code of the intelligent contract to construct an abstract syntax tree of the source code; traversing the abstract syntax tree to supplement node information of the abstract syntax tree, and extracting a control flow graph and read-write variable information of the intelligent contract from the supplemented abstract syntax tree; acquiring an execution path set of the intelligent contract according to the control flow graph, and acquiring a data flow analysis result of the intelligent contract according to the read-write variable information; customizing a vulnerability detector according to a data flow analysis result and the abstract syntax tree, and applying the vulnerability detector to each path of the execution path set; and traversing the abstract syntax tree to obtain a detection result of the vulnerability detector, and inputting the detection result into the JSON file. However, without considering the data flow graph and the control flow graph to construct an abstract syntax tree with semantic information, the known solution is not satisfying in terms of accuracy when used to detect complex vulnerabilities. As a further example, China Patent Publication No. CN115828264A discloses an intelligent contract vulnerability detection method, system and electronic equipment. The method comprises respectively carrying out lexical analysis and abstract syntax tree analysis on an intelligent contract program code, generating a related symbol list and a tree structure, examining the intelligent contract program code and executing a static analysis process so as to realize the basic detection of the intelligent contract vulnerabilities; extracting a key path based on an improved symbolic execution method and generating a test case, wherein the test case is an unexpected input; and optimizing the test case based on an improved fuzzy test method and performing fuzzy test to obtain a test result. Nevertheless, in the known method, the symbol execution step and the fuzzy test step can consume considerable computing resources and time. Besides, as the known method is unable to locate vulnerabilities, the developer has to manually search for vulnerabilities in the code, making vulnerability remediation complicated and time-consuming.

Since there is certainly discrepancy between the existing art comprehended by the applicant of this patent application and that known by the patent examiners and since there are many details and disclosures disclosed in literatures and patent documents that have been referred by the applicant during creation of the present disclosure not exhaustively recited here, it is to be noted that the present disclosure shall actually include technical features of all of these works in the art known by the inventor(s), and the applicant reserves the right to supplement the application with the related art more existing technical features as support according to relevant regulations.

### SUMMARY

Although an abstract syntax tree in the art known by the inventor(s) reflects the rich structural information of a program in terms of syntax, it contains merely syntactic information, without any semantic information, such as the control flow and the data flow, whereas use of a control flow graph in detection also fails to provide data flow information. Furthermore, most control flow graphs merely cover control flows among code blocks, leaving low-level syntactic structures in code blocks ignored. Meanwhile, in some programming languages, a control flow graph is more difficult to obtain than an abstract syntax tree. Consequently, a vulnerability type, even when identified, cannot be preciously located, and a developer using such a tool thus has to search for vulnerabilities among hundreds of lines of codes.

In view of the shortcomings of the existing art, the present disclosure provides a system for vulnerability localization based on deep learning. The system may comprise a processor. The processor is for: analyzing a code file under detection so as to obtain a first abstract syntax tree that does not contain semantic information; adding a data-flow edge and/or a control-flow edge to the first abstract syntax tree to form a second abstract syntax tree with semantic-flow enhancement; splitting the second abstract syntax tree to obtain a plurality of second abstract syntax sub-trees; and entering the second abstract syntax sub-trees into a pre-established vulnerability detection and localization model.

In the present disclosure, the control flow and the data flow are added to the abstract syntax tree to form a second abstract syntax tree with semantic-flow enhancement, and the second abstract syntax tree is then split in a fine-grained manner, thereby realizing detection and localization of code vulnerabilities.

Preferably, the step of adding a data-flow edge and/or a control-flow edge to the first abstract syntax tree may comprise any of the following: connecting each non-root node to a parent node thereof; establishing connection relationships among peer nodes and/or terminal nodes; connecting nodes involving the variables based on the sequence of variable occurrences; and connecting nodes embodying program control semantics through controlled information.

By enhancing the control flow and the data flow in the first abstract syntax tree, the syntactic and semantic structures in the abstract syntax tree can be easily captured in subsequent works, thereby making full use of the structural information of code snippets.

Preferably, the step of establishing connection relation among peer nodes may comprise: connecting each said node to its peer sibling nodes, so as to provide a neural network model with an order of child nodes.

Preferably, the step of establishing connection relation among terminal nodes may comprise: connecting one said terminal node to a following said terminal node so as to connect a plurality of labels that are related to the source code. In the present disclosure, connection of sibling nodes, connection of terminal nodes, node connection based on the order of variables, and node connection based on controlled information jointly enhance the semantic flow. The special node connection makes the present disclosure suitable for semantic vulnerabilities having different syntactic features, and highly adaptable to various programming languages.

Preferably, the step of splitting the second abstract syntax tree may comprise: acquiring a sub-tree node sequence of at least one code block; according to a complexity order of statement types, sorting statements of different said statement types in the source code; selecting at least one said statement type that takes a top place in the complexity order of the statement types; and according to the complexity order of the statement types, determining how the statement type is to be split.

Preferably, the step of, according to a complexity order of statement types, sorting statements of different said statement types in the source code comprises: compiling method information in data sets related to individual code blocks; determining complexity of the individual statement types based on a mean value of the nodes; and according to complexity, sorting statements of different said statement types in the source code.

Preferably, while selecting at least one said statement type that takes a top place in the complexity order of the statement types, the statement type is at least one of a For statement type, a While statement type, a Try statement type, a Do statement type, a ForEach statement type, a Switch statement type, and an If statement type. With the special way to split the second abstract syntax tree, the present disclosure can well preserve the node sequence of the extracted abstract syntax tree.

Preferably, the vulnerability detection and localization model may comprise a treeLSTM vector coding model and a graph-attention-based model. By combining the graph-attention-based vulnerability detection and localization model and the second abstract syntax sub-tree splitting method, the present disclosure realizes localization of vulnerability codes.

The present disclosure further provides a method for vulnerability localization based on deep learning, the method may comprise: analyzing a code file under detection so as to obtain a first abstract syntax tree that does not contain semantic information; adding a data-flow edge and/or a control-flow edge to the first abstract syntax tree to form a second abstract syntax tree with semantic-flow enhancement; splitting the second abstract syntax tree to obtain a plurality of second abstract syntax sub-trees; and entering the second abstract syntax sub-trees into a pre-established vulnerability detection and localization model.

The disclosed method for vulnerability localization based on deep learning adds data-flow edges and control-flow edges to the first abstract syntax tree, so that the syntactic and semantic structures in the abstract syntax tree can be easily captured, thereby making full use of the structural information of code snippets. The second abstract syntax tree of the present disclosure has its node sequence preserved. By traversing the whole abstract syntax tree and recording the traversed nodes, the node sequence can be determined.

Preferably, the method further comprises: connecting each non-root node to a parent node thereof; establishing connection relation among sibling nodes and/or terminal nodes; based on an occurrence order of variables, connecting nodes involving the variables; and connecting nodes involving the variables based on the sequence of variable occurrences.

Connecting nodes that embody program control semantics enables effective utilization of control flow information within the source code.

### BRIEF DESCRIPTION OF THE DRAWINGS

FIG. 1 is a logic module diagram of a method for detecting and locating vulnerabilities according to a preferred mode of the present disclosure;

FIG. 2 is a schematic diagram illustrating construction of a flow-enhanced second abstract syntax tree according to a preferred mode of the present disclosure;

FIG. 3 is a structural diagram of the vulnerability detection model and the vulnerability localization model of the present disclosure;

FIG. 4 is a logic diagram of the first abstract syntax tree in an application of the present disclosure; and

FIG. 5 is a logic diagram of the second abstract syntax tree in an application of the present disclosure.

### DETAILED DESCRIPTION

The present disclosure will be described in detail with reference to the accompanying drawings.

Some terms used in this disclosure shall have the definitions given below.

An Abstract Syntax Tree (AST) represents a hierarchical depiction of the underlying syntactic structure within a source code. Each node in such a tree symbolizes a distinct structural element within the code. Unlike a literal syntax representation, ASTs do not account for every minute detail—e.g., nested parentheses are encapsulated within the overall structure rather than explicitly depicted as separate nodes. The AST construction remains impartial to the specific syntax of the source language and relies on context-free grammars during syntactic analysis. Any non-essential transformations applied during the grammar writing process can potentially introduce extraneous elements to the analysis, leading to detrimental effects or even disorder in subsequent stages.

The first abstract syntax tree can reflect the rich structural information of a program in terms of syntax, but it contains merely syntactic information, without any semantic information. The semantic information is, for example, the control flow and the data flow.

The second abstract syntax tree refers to an abstract syntax tree with control-flow edges and data-flow edges added therein according to the present disclosure.

A data-flow edge is represented by an arrow that shows the direction in which the data flows. Data-flow edges indicate data dependency in a code by showing propagation and changes of the data in a program. A data-flow edge describes how data are read, propagated and altered across different statements. A data-flow edge is used to represent flow of data during execution of a program, and helps understand data dependency and data changes in a code.

A control-flow edge is represented by an arrow that points to the next statement to be executed or the destination of a jump. Control-flow edges indicate transfer of the control flow in a code by showing the path of code execution. Control-flow edges describe jump relationship between statements like conditional branches, loops, and function calling. A control-flow edge represents the control process for executing the program, and helps understand the execution order and process of a code.

A semantic flow exists between two layers in a feature pyramid. It represents “movement” of every pixel from one feature map to another feature map.

A processor may be an ASIC, a server, a server cluster, a CPU, or the like that is able to operate a coding program of the disclosed method for vulnerability localization based on deep learning. In particular cases, a processor according to the present disclosure may alternatively be an assembly of primary hardware, such as a single-chip microcomputer, a logic programmer or so, for implementing the method of the present disclosure.

In the art known by the inventor(s), an abstract syntax tree of a program code is generated through lexical analysis and syntactic analysis. It reflects the syntactic structure of the code, including relations among various syntactic elements. Such an existing abstract syntax tree is neither able to capture semantic information related to behavior of the program, nor to address some issues related to semantic ambiguity. Besides, existing abstract syntax trees typically exclude context information like comments, blank characters, and program typesetting, and overlook details of some particular language. All these can have adverse impacts on an abstract syntax tree for its analysis and understanding of code behavior and in turn prevent the final analysis results being accurate.

In the existing art, there are some common defects existing in results of vulnerability detection. Firstly, false positives can often happen in which codes are mistakenly reported as being subject to attacks. This is usually caused by limits or incompleteness of the rule-pattern matching algorithms, and vulnerabilities existing in inaccessible codes. Secondly, static application security testing tools are less capable of detecting complex context vulnerabilities, making them ineffective in identifying codes subject to attacks. This is also the consequence of limits or incompleteness of the rule-pattern matching algorithms.

Existing vulnerability detection models often look to the entire function or code region for their detection, and cannot locate a found vulnerability type. This means that a developer using such a tool has to search for vulnerabilities in hundreds of lines of codes. What is even worse is that if the used tool does not conduct classification of vulnerabilities, the developer does not even know what to look for or what to do to remedy the weakness. With the high frequency of false positives seen in the existing machine learning technology, such a problem can aggravate. The foregoing methods often make predications for the entire functions or code regions, but fail to provide specific location pinpointing for the types of vulnerabilities detected. This means that a developer using such a tool has to search for vulnerabilities in hundreds of lines of codes. If the used tool does not conduct classification of vulnerabilities, the search will be even more difficult as the developer does not know what to look for or what to do to remedy the weakness. With the high frequency of false positives seen in the existing machine learning technology, this issue is further exacerbated.

To address the shortcomings of the existing art, the inventor of the present disclosure improves the existing abstract syntax tree so that the syntactic and semantic structures of an abstract syntax tree can be easily captured, thereby allowing structural information of code snippets to be fully used. The second abstract syntax tree according to the present disclosure is configured to work with a neural-network-based vulnerability detection model. The model acquires intermediate outputs of a multi-head graph attention neural network, i.e., attention matrix values of individual sub-tree vector representations, and identify the vector representation having the greatest value. The sub-tree corresponding to the vector is the statement block where the vulnerable code exists. Then the exact location of the vulnerable code can be determined using the backtracking function of the abstract syntax tree, thereby achieving high-accuracy vulnerability localization.

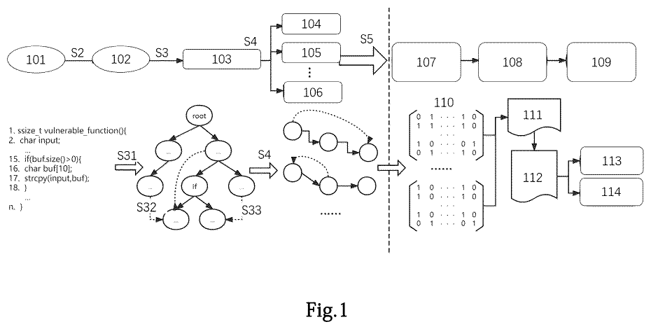

Specifically, as shown in FIG. 1, the disclosed system for vulnerability localization based on deep learning comprises a processor. The processor may be in any number and of any style. It may be one processor, or be two or more processor sub-units connected to each other. The processor may be provided with a plurality of data interface for receiving and/or outputting information. The received information may include the code file under detection. The output information may include detection result information 113 and/or localization result information 114.

It is to be noted that the steps in the disclosed method shall be execute in any order according to practical needs and not limited to their ordinal numbers. In the present disclosure, the detection result information and the localization result information may be output together or separately, depending on practical needs.

The processor of the present disclosure is designed to operate the method for vulnerability localization based on deep learning of the present disclosure.

The method for vulnerability localization based on deep learning may comprise the following steps:
S2: analyzing a code file under detection so as to obtain a first abstract syntax tree that does not contain semantic information;
S3: adding data-flow edges and/or control-flow edges to the first abstract syntax tree to form a second abstract syntax tree with semantic-flow enhancement;
S4: splitting the second abstract syntax tree to obtain a plurality of second abstract syntax sub-trees; and
S5: entering the second abstract syntax sub-trees into a pre-established vulnerability detection and localization model.

Each of the steps will be detailed in the following paragraphs.

To analyze a code file under detection so as to obtain a first abstract syntax tree that does not contain semantic information as performed in S2, the following steps are conducted.

At S21, lexical analysis is performed on the source code 101 in the code file under detection.

The source code 101 is input to a lexical analyzer, for the lexical analyzer to output word symbols. The word symbols include five fundamental syntactic symbols of the programming language. The five fundamental syntactic symbols are, for example, keywords, identifiers, constants, operators, and delimiters.

At S22, syntactic analysis is performed on the word symbols, so as to obtain the first abstract syntax tree 102 lacking any semantic information.

For instance, Joern is used to perform lexical analysis and syntactic analysis. Joern generates intermediate representations of the input codes in the code analysis phase, which include the first abstract syntax tree, the control flow graph, and the data dependency graph. Then in the rule parse phase, attributes and nodes of all these graphs are packed into objects.

At S3, data-flow edges and/or control-flow edges are added to the first abstract syntax tree so as to form a second abstract syntax tree with semantic-flow enhancement.

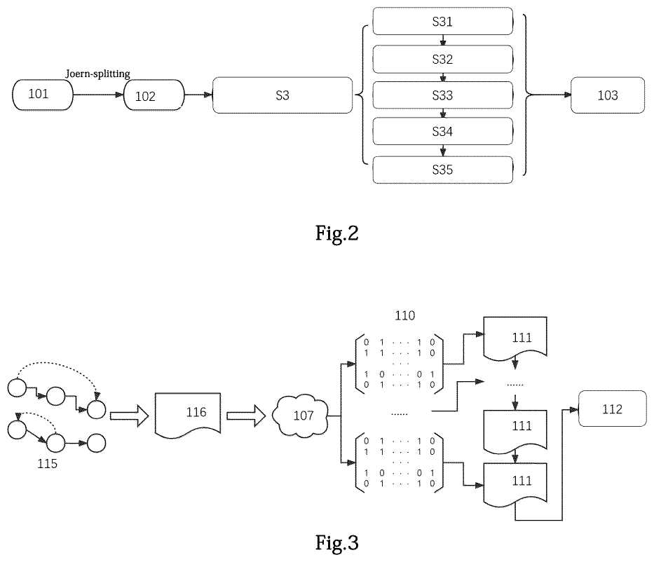

By adding program data-flow edges, program control-flow edges and program order-flow edges to the first abstract syntax tree, a second abstract syntax tree 103 with semantic-flow enhancement can be obtained. FIG. 2 illustrates construction of the second abstract syntax tree 103 containing semantic information.

To be particular, at S31, program order-flow edges are added to connect non-terminal nodes to individual child nodes.

At S32, program control-flow edges are added to connect non-root nodes to their parent nodes.

At S33, program data-flow edges are added to establish connection relation among sibling nodes and/or terminal nodes.

Addition of program data-flow edges, program control-flow edges and program order-flow edges helps capture data propagation, the control process and the execution order in the program, thereby providing more accurate and more comprehensive representations of semantic structures, and in turn facilitating understanding and maintenance of the code and supports use of automated tools.

Specifically, nodes are connected to the peer sibling nodes, so as to provide a neural network model with an order of child nodes. This is about connecting a node to the following peer node, i.e., its first right-hand sibling node. Since the order of nodes is not considered in a graph neural network, it is necessary to provide the neural network model with the order of child nodes.

A terminal node is connected its following terminal node, so as to connect labels that are related to the source code. In an abstract syntax tree, a terminal node represents an identifier in the source code file, so its following terminal node refers to a terminal node corresponding to the identifier subsequently occurring in the source code file.

S34 is about connecting the nodes involving the variables based on the occurrence order of variables.

According to the order by which variables occurring in the source code, the nodes corresponding to the same variable are connected successively. To be specific, this is about connecting a node using a variable to the place where the variable appears next time. This step allows effective use of the data flow information in the abstract syntax tree formed from the source code.

A node using a variable is connected to the place where the variable appears next time. This step allows effective use of the data flow information of the source code.

At S35, based on controlled information, nodes having program control semantics are connected.

In this step, the control flow type at least comprises order execution statement, assume statement and loop statement.

Specifically, an order execution statement may include child nodes in any number. According to the statement execution order, the root node of each statement and its sibling node are connected. In particular, according to statement execution order, the root node of a statement is connected to the root node of the statement next to be executed.

Specifically, an assume statement contains two or three child nodes. The first child node is an assumed condition. The second child node is the statement body to be held when the condition is true. Where there is an assume body to be held when the condition is false, that is the third child node. Connect the first node to the second node, and then connect the first node to the third node.

Specifically, the loop statement comprises two child nodes. The first child node is the condition, and the second child node is the statement body to be held when the condition is true. Connect the first child node to the second child node, and inversely connect the second node back to the first node, signifying a return to the conditional check after the execution of the statement body.

The node having program control semantics is connected to where a node under its control is located. This step effectively utilizes the control flow information within the source code.

At S4, the second abstract syntax tree 103 is split through the following steps.

At S41, Acquire a sequence of sub-tree nodes for at least one code block.

At S42, Sort different types of statements in the source code based on the complexity of statement types.

Therein, S421 is about compiling method information in data sets related to individual code blocks. The method information refers to the function information, which is used for classification of statements in the data sets. The method information may be a For statement, a While statement, an If statement, a ForEach statement, etc. Every statement represents a class. Statements of the same type are in the same classification type.

Preferably, gather statistics on all method information. Specifically, calculate separately the total number of statements for each statement type, as well as the total number of nodes in the abstract syntax trees corresponding to all statements within that type.

S422 is about determining complexity of the individual statement types based on a mean value of the nodes.

Specifically, for every statement type, the number of the nodes in the abstract syntax tree corresponding to all statements in each type is divided by the number of the statements in corresponding statement type, and the result is the complexity of each corresponding statement type.

S423 is about, sorting statements of different said statement types in the source code according to the complexity.

At S43, select at least one statement type with the highest complexity ranking based on the sorted complexity of statement types.

The statement type is at least one of the For statement type, the While statement type, the Try statement type, the Do statement type, the ForEach statement type, the Switch statement type, and the If statement type.

Preferably, the top seven statement types in the complexity order of the statement types are selected.

The number of nodes in an abstract syntax tree composed of statements is directly proportional to how complex the corresponding statement type is. An abstract syntax tree corresponding to low-complexity statements has fewer nodes then an abstract syntax tree corresponding to high-complexity statements. Based on this, according to the complexity order of different statement types in a source code, abstract syntax trees having more nodes can be split preferentially.

S44 is about determining how the statement type is to be split according to the complexity order of the statement types.

Specifically, whether a statement type has to be split is determined according to its complexity.

The specific splitting rules are as below.

For a low-complexity statement, no splitting is performed. The statement is left in the flow-enhanced second abstract syntax tree as is.

A high-complexity statement is taken off from the second abstract syntax tree and forms a sub-tree. Only the root node of such a sub-tree is left in the second abstract syntax tree.

With statement types selected to be split according to their complexity, the resulting sub-trees have roughly equalized numbers of nodes. This prevents unnecessary temporal and spatial costs that would be otherwise consumed when significant differences of numbers of codes exist among sub-trees.

At S45, the step S44 is repeated until the second abstract syntax tree is eventually split into plural sub-trees and the rest of the second abstract syntax tree forms a structure sub-tree.

As shown in FIG. 1 and FIG. 2, the second abstract syntax tree 103 is split into: the first type sub-tree 104, the second type sub-tree 105, . . . , the Nth type sub-tree 106.

In the present disclosure, the second abstract syntax tree is split in the way that the node sequence of the extracted abstract syntax tree can be completely preserved without using the complicated abstract syntax tree for computing. By traversing the entire abstract syntax tree and recording the traversed node, the node sequence can be obtained. The present disclosure allows an abstract syntax tree to be reasonably split into statement sub-trees and structure sub-trees specific to different types, thereby reducing complexity and in turn significantly lowering temporal and spatial costs.

At S5, the second abstract syntax sub-trees are input to a pre-established vulnerability detection and localization model.

The vulnerability detection and localization model are constructed on the basis of a graph neural network. The vulnerability detection and localization model may comprise a treeLSTM vector coding model 107 and a graph-attention-based model 108. The graph-attention-based model 108 outputs information for detection and classification with localization 109.

The process of detecting vulnerabilities and locating vulnerabilities based on the treeLSTM vector coding model 107 is described below with reference to FIG. 3.

First, a pre-trained language model, word2vec coding 116, extracts lexical representation vector from every sub-tree node in a sub-tree, and adds different types of semantic flow edge information (e.g., data flow, control flow) into the node semantic representation vector as a dimension of the vector. In FIG. 3, the sub-trees are represented by their graph representation forms 115.

All of the node vector representation corresponding to a sub-tree are entered into the treeLSTM vector coding model 107 for extraction of semantic information and extraction of relationship, so as to obtain vector representations that can completely reflect information of the sub-tree.

The treeLSTM vector coding model 107 further labels every input sub-tree of the abstract syntax tree with a corresponding vulnerability information label. If there is no vulnerability existing in functions associated to a sub-tree, the sub-tree is labelled as ‘0’, which indicates that it is a negative sample. If there is a vulnerability existing in functions associated to a sub-tree, the sub-tree is labelled as ‘1’, which indicates that it is a positive sample. Thereby, a 2-tuple data set composed of the sub-tree representation vector and the label 0 or 1 can be obtained.

As shown in FIG. 3, the graph-attention-based vulnerability detection and localization model structurally comprises: eight multi-head graph attention layers 111, a Softmax function layer, and an output layer 112. The eight multi-head graph attention layers are connected to eight sub-tree vector representations, respectively. Weights of individual vectors are calculated and integrated into a single cointegrating vector that represents the semantic characteristic of the whole source code.

Specifically, with a deep learning model, the query vector is determined according to the actual task and the context. The dot product of the query vector and each sub-tree vector representation is the weight of each vector. A weight is used to measure how the query vector is related to or similar to the corresponding sub-tree vector representation. The calculated weights of the individual vectors are normalized to ensure that each of them is between 0 and 1, and their sum is 1. The normalized weights of the vectors are compared. Accordingly, a sub-tree vector representation corresponding to a vector having a higher weight is accentuated and a sub-tree vector representation corresponding to a vector having lower weight is suppressed.

Then the semantic characteristic is processed by the Softmax layer and the output layer 112 to produce the forecast vulnerability classification result of the vector. On this basis, by acquiring the sub-tree vector representation attention with the greatest weight as determined by the attention layer, the statement block in which a vulnerability exists can be identified. Then in the attention matrix value, the sum of the matrix values of individual vectors of each statement block in the sub-tree is calculated as the total weight, so as to identify statement block having the greatest total weight. The statement block having the greatest total weight is the location related to a vulnerability. Afterward, with the backtracking function of the abstract syntax tree, the code line in which a vulnerability exists can be identified.

In the deep learning model, by acquiring intermediate outputs of a multi-head graph attention neural network, which are the attention matrix values of individual sub-tree vector representations, the vector representation with the greatest value can be identified. The sub-tree corresponding to the vector is the statement block in which the vulnerability code is present. With the backtracking function of the abstract syntax tree, vulnerabilities can be accurately located, precise to the line, thereby achieving accurate vulnerability localization.

After the vulnerability localization information is obtained using the vulnerability localization method of the present disclosure, a vulnerability alert may be given accordingly. To this end, the present disclosure may further provide an information security alert system based on the disclosed vulnerability localization method. The information security alert system of the present disclosure may be used for integration during software development, such as in a pipe for continuous integration or continuous delivery. After a developer submits the code, the vulnerability localization system may operate automatically, and gives alert information or recommendation information for potential vulnerabilities, so as to help reduce vulnerabilities in the process of software development, thereby maximizing security and operational smoothness of the resulting software product.

After the vulnerability localization information is obtained using the vulnerability localization method of the present disclosure, security risk assessment for the application may be conducted accordingly. To this end, the present disclosure also capable of providing a security assessment system predicated upon the vulnerability localization method disclosed herein. The security assessment system is applicable to security assessment for enterprise applications. The system can analyze a code from a third party to identify potential vulnerabilities therein and provide security risk assessment.

The present disclosure may further be implemented as practical application systems on the basis of the vulnerability localization method of the present disclosure, such as education and training systems, code review systems, and mobile application development. These systems provide services in some daily-life scenarios.

One example in which the present disclosure is applied is herein described to further explain operation of the present disclosure.

A program code segment contains a time loop code segment, wherein the integers at the top of a given stack receive duplicate removal through pop operation.

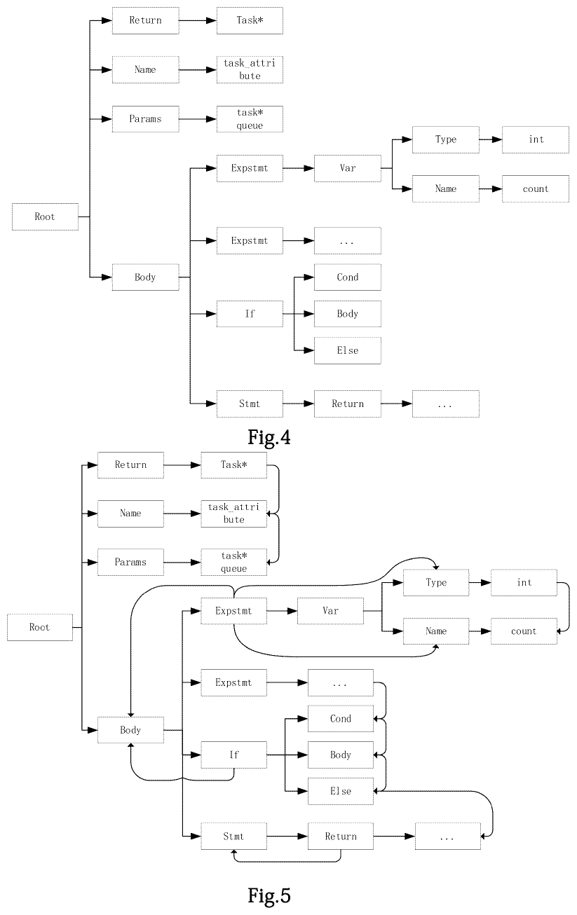

The program operating in the disclosed apparatus first analyzes the program code segment to obtain the first abstract syntax tree without semantic information. FIG. 4 schematic shows the first abstract syntax tree through the analysis.

According to the logic relationship in the first abstract syntax tree, data-flow edges, program control-flow edges and program order-flow edges are added, respectively, to generate a corresponding second abstract syntax tree. FIG. 5 depicts the second abstract syntax tree so formed. By comparing FIG. 5 and FIG. 4, it is clear that FIG. 5 has arrow symbols representing the added data-flow edges, program control-flow edges, and program order-flow edges.

The second abstract syntax tree of FIG. 5 is then split. The function information in the program code segment is compiled. A program code segment involving high complexity statement types, like an If statement type, is split to form a second abstract syntax sub-tree. The rest of the statements, such as While statements, are not further split due to their low complexity.

The second abstract syntax sub-trees are then entered to the pre-trained vulnerability detection and localization model. In the vulnerability detection and localization model, since the statement blocks formed by 6-11 lines are given the greatest weight, a sub-tree constructed therefrom is labelled with the corresponding vulnerability information label, which designates it as a positive sample for this particular vulnerability. Then the backtracking function of the abstract syntax tree is used to accurately locate it in the source code. For example, the model detects there is out-of-bounds access vulnerability in the statement block, which means if the queue is smaller than avg_task_num, meaningless popping of queue data may arise and cause out-of-bounds behavior related to underflow exception. This weakness can be remedied by setting the initial size of the queue before an If statement and ensuring that it is greater than avg_task_num or checking that the queue is not null before it.

After the vulnerability localization information is obtained, a vulnerability alert may be given accordingly.

It is to be noted that the particular embodiments described previously are exemplary. People skilled in the art, with inspiration from the disclosure of the present disclosure, would be able to devise various solutions, and all these solutions shall be regarded as a part of the disclosure and protected by the present disclosure. Further, people skilled in the art would appreciate that the descriptions and accompanying drawings provided herein are illustrative and form no limitation to any of the appended claims. The scope of the present disclosure is defined by the appended claims and equivalents thereof. The disclosure provided herein contains various inventive concepts, such of those described in sections led by terms or phrases like “preferably”, “according to one preferred mode” or “optionally”. Each of the inventive concepts represents an independent conception and the applicant reserves the right to file one or more divisional applications therefor.

What is claimed is:

1. A system for vulnerability localization based on deep learning, the system at least comprising a processor, wherein the processor is for:
analyzing a code file under detection so as to obtain a first abstract syntax tree that does not contain semantic information;
adding data-flow edges and/or control-flow edges to the first abstract syntax tree to form a second abstract syntax tree with semantic-flow enhancement;
splitting the second abstract syntax tree to obtain a plurality of second abstract syntax sub-trees; and
entering the second abstract syntax sub-trees into a pre-established vulnerability detection and localization model.

2. The system of claim 1, wherein the step of adding data-flow edges and/or control-flow edges to the first abstract syntax tree comprises at least one of following steps:
connecting each non-root node to a parent node thereof;
establishing connection relation among peer nodes and/or terminal nodes;
based on an occurrence order of variables, connecting nodes involving the variables; and
based on controlled information, connecting nodes having program control semantics.

3. The system of claim 2, wherein the step of establishing connection relation among peer nodes at least comprises:
connecting each said node to its peer sibling nodes, so as to provide a neural network model with an order of child nodes.

4. The system of claim 3, wherein the step of establishing connection relation among terminal nodes at least comprises:
connecting one said terminal node to a following said terminal node so as to connect a plurality of labels that are related to a source code.

5. The system of claim 4, wherein the step of splitting the second abstract syntax tree at least comprises:
acquiring a sub-tree node sequence of at least one code block;
according to a complexity order of statement types, sorting statements of different said statement types in the source code;
selecting at least one said statement type that takes a top place in the complexity order of the statement types; and
according to the complexity order of the statement types, determining how the statement type is to be split.

6. The system of claim 5, wherein the step of, according to a complexity order of statement types, sorting statements of different said statement types in the source code comprises:
compiling method information in data sets related to individual code blocks;
determining complexity of the individual statement types based on a mean value of the nodes; and
according to complexity, sorting statements of different said statement types in the source code.

7. The system of claim 6, wherein in the step of selecting at least one said statement type that takes a top place in the complexity order of the statement types,
the statement type is at least one of a For statement type, a While statement type, a Try statement type, a Do statement type, a ForEach statement type, a Switch statement type, and an If statement type.

8. The system of claim 7, wherein the vulnerability detection and localization model at least comprise a treeLSTM vector coding model and a graph-attention-based model.

9. The system of claim 8, wherein the control flow and the data flow are added to the abstract syntax tree to form a second abstract syntax tree with semantic-flow enhancement, and the second abstract syntax tree is then split in a fine-grained manner, thereby realizing detection and localization of code vulnerabilities.

10. The system of claim 9, wherein by combining the graph-attention-based vulnerability detection and localization model and the second abstract syntax sub-tree splitting method, localization of vulnerability codes is realized.

11. A method for vulnerability localization based on deep learning, the method at least comprising:
analyzing a code file under detection so as to obtain a first abstract syntax tree that does not contain semantic information;
adding a data-flow edge and/or a control-flow edge to the first abstract syntax tree to form a second abstract syntax tree with semantic-flow enhancement;
splitting the second abstract syntax tree to obtain a plurality of second abstract syntax sub-trees; and
entering the second abstract syntax sub-trees into a pre-established vulnerability detection and localization model.

12. The method of claim 11, wherein the step of adding a data-flow edge and/or a control-flow edge to the first abstract syntax tree is achieved through at least one of following steps:
connecting each non-root node to a parent node thereof;
establishing connection relation among peer nodes and/or terminal nodes;
based on an occurrence order of variables, connecting nodes involving the variables; and
based on controlled information, connecting nodes having program control semantics.

13. The method of claim 12, wherein the step of establishing connection relation among peer nodes at least comprises:
connecting each said node to its peer sibling nodes, so as to provide a neural network model with an order of child nodes.

14. The method of claim 13, wherein the step of establishing connection relation among terminal nodes at least comprises:
connecting one said terminal node to a following said terminal node so as to connect a plurality of labels that are related to a source code.

15. The method of claim 14, wherein the step of splitting the second abstract syntax tree at least comprises:
acquiring a sub-tree node sequence of at least one code block;
according to a complexity order of statement types, sorting statements of different said statement types in the source code;
selecting at least one said statement type that takes a top place in the complexity order of the statement types; and
according to the complexity order of the statement types, determining how the statement type is to be split.

16. The method of claim 15, wherein the step of, according to a complexity order of statement types, sorting statements of different said statement types in the source code comprises:
compiling method information in data sets related to individual code blocks;
determining complexity of the individual statement types based on a mean value of the nodes; and
according to complexity, sorting statements of different said statement types in the source code.

17. The method of claim 16, wherein in the step of selecting at least one said statement type that takes a top place in the complexity order of the statement types,
the statement type is at least one of a For statement type, a While statement type, a Try statement type, a Do statement type, a ForEach statement type, a Switch statement type, and an If statement type.

18. The method of claim 17, wherein the vulnerability detection and localization model at least comprise a treeLSTM vector coding model and a graph-attention-based model.

19. The method of claim 18, wherein the control flow and the data flow are added to the abstract syntax tree to form a second abstract syntax tree with semantic-flow enhancement, and the second abstract syntax tree is then split in a fine-grained manner, thereby realizing detection and localization of code vulnerabilities.

20. The method of claim 19, wherein by combining the graph-attention-based vulnerability detection and localization model and the second abstract syntax sub-tree splitting method, localization of vulnerability codes is realized.
